(19) United States
(12) Patent Application Publication
(10) Pub. No.: US 2023/0410143 A1
(43) Pub. Date: Dec. 21, 2023

(54) DETECTING ANOMALIES IN LIVE MARKETING CAMPAIGN DATA

(71) Applicant: Oracle International Corporation, Redwood Shores, CA (US)

(72) Inventors: Paul Deepakraj Retinraj, Fremont, CA (US); Sanjana Arun, Sunnyvale, CA (US); Roma Khimani, Bangalore (IN); Saurabh Surendra Shastri, Pune (IN)

(73) Assignee: Oracle International Corporation, Redwood Shores, CA (US)

(21) Appl. No.: 17/830,851

(22) Filed: Jun. 2, 2022

Related U.S. Application Data
(60) Provisional application No. 63/347,149, filed on May 31, 2022.

(51) Int. Cl. G06Q 30/02

(52) U.S. Cl. CPC G06Q 30/0244; G06Q 30/0243

(57) ABSTRACT

Techniques for detecting anomalies in live marketing campaign data are disclosed, including: obtaining baseline data associated with one or more digital marketing campaigns; configuring an anomaly detection model to detect anomalies in digital marketing data, based at least on the baseline data; receiving a live stream of a set of digital marketing data associated with a particular digital marketing campaign that is currently being executed; while the particular digital marketing campaign is being executed: applying the anomaly detection model to the set of digital marketing data, to determine if the set of digital marketing data includes an anomaly relative to the baseline data; prior to completion of the particular digital marketing campaign and responsive to determining that the set of digital marketing data includes the anomaly relative to the baseline data, executing an action to address the anomaly.

### INCORPORATION BY REFERENCE; DISCLAIMER

The following application is hereby incorporated by reference: Provisional application No. 63/347,149 filed on May 31, 2022. The applicant hereby rescinds any disclaimer of claims scope in the parent application(s) or the prosecution history thereof and advise the USPTO that the claims in the application may be broader that any claim in the parent application(s).

### TECHNICAL FIELD

The present disclosure relates to detecting anomalies in live data. In particular, the present disclosure relates to detecting anomalies in live marketing campaign data.

### BACKGROUND

Digital marketing uses computer networks (e.g., the Internet, mobile phone networks, etc.) to present marketing materials to potential customers on digital devices. Some examples of digital marketing include search engine marketing, advertisements on websites, social media marketing, content marketing (e.g., blog posts, online videos, etc.), text message marketing, etc. Some marketing materials may be distributed across multiple marketing platforms. For example, a blog post may also be shared on social media. A set of digital marketing materials with a common purpose (e.g., to promote a specific product or service, raise brand awareness, etc.) is referred to as a digital marketing campaign.

A digital marketer is a person responsible for managing one or more digital marketing campaigns. Typically, a marketer logs into a digital marketing platform to configure a campaign. Once the campaign is live, the platform receives data that can be interpreted to derive insights into how well the campaign is performing. For example, when somebody interacts with the campaign—such as by clicking a link, entering contact information, or responding to a text message—information about the interaction may be gathered and transmitted to the platform. Insights into a campaign's performance may include metrics such as views, clicks, leads (e.g., email addresses and/or phone numbers gathered in connection with the campaign), conversions to sales, etc.

To monitor a campaign's performance, a marketer may access the platform (e.g., via a desktop- or web-based interface) to view performance metrics. Being human, the marketer cannot realistically monitor the campaign continuously or respond in real-time to campaign data as it enters the platform. Instead, the platform presents aggregated performance metrics for some period of time. For example, the platform may present metrics for a particular day, week, month, quarter, etc. Based on the aggregated metrics, the marketer may instruct the platform to modify some aspect of the campaign, such as adjusting a spend rate, suspending the campaign, adding or removing a keyword, revising marketing text, adjusting targeting parameters, etc. A marketer cannot devote their attention to continuing to monitor a campaign while simultaneously modifying the campaign.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. References to “an” or “one” embodiment in this disclosure are not necessarily to the same embodiment and mean at least one. In the drawings:

FIG. 1 shows a block diagram that illustrates an example of a system in accordance with one or more embodiments;

FIGS. 2A-2B illustrate an example set of operations for detecting anomalies in live marketing campaign data in accordance with one or more embodiments;

FIGS. 3A-3E illustrate examples of graphical user interfaces (GUIs) for a digital marketing platform in accordance with one or more embodiments; and

FIG. 4 shows a block diagram that illustrates a computer system in accordance with one or more embodiments.

### DETAILED DESCRIPTION

In the following description, for the purposes of explanation and to provide a thorough understanding, numerous specific details are set forth. One or more embodiments may be practiced without these specific details. Features described in one embodiment may be combined with features described in a different embodiment. In some examples, well-known structures and devices are described with reference to a block diagram form, in order to avoid unnecessarily obscuring the present invention.

The following table of contents is provided for reference purposes only and should not be construed as limiting the scope of one or more embodiments.
1. GENERAL OVERVIEW
2. EXAMPLE SYSTEM
2.1. SYSTEM COMPONENTS
2.2. DATA STORAGE
2.3. USER INTERFACE
2.4. TENANTS
2.5. MACHINE LEARNING
3. DETECTING ANOMALIES IN LIVE MARKETING CAMPAIGN DATA
3.1. CONFIGURING A DIGITAL MARKETING CAMPAIGN
3.2. OBTAINING BASELINE DATA
3.3. CONFIGURING AN ANOMALY DETECTION MODEL
3.4. OBTAINING DIGITAL MARKETING DATA
3.5. DETECTING AND SCORING ANOMALIES
3.6. ADDRESSING ANOMALIES
3.7. UPDATING THE ANOMALY DETECTION MODEL
4. EXAMPLE EMBODIMENTS
4.1. EXAMPLE USE CASES
4.2. EXAMPLE USER INTERFACES
5. COMPUTER NETWORKS AND CLOUD NETWORKS
6. MICROSERVICE APPLICATIONS
6.1. TRIGGERS
6.2. ACTIONS
7. HARDWARE OVERVIEW
8. MISCELLANEOUS; EXTENSIONS

### 1. GENERAL OVERVIEW

One or more embodiments detect anomalies in live marketing campaign data. To detect an anomaly, a digital marketing platform applies an anomaly detection model to the live marketing campaign data. As anomalies arise, the platform is able to detect them quickly and recommend actions for addressing them. Approaches described herein provide a technical improvement over digital marketing platforms that do not allow for ongoing, unsupervised monitoring of live digital marketing data associated with one or more digital marketing campaigns. One or more embodiments are able to process a volume and complexity of digital marketing data that a human marketer cannot realistically hope to process. In addition, one or more embodiments use machine learning to determine data trends based on similar campaigns, and/or to detect anomalies. In a multi-tenant environment (discussed in further detail herein), machine learning may improve data security by deriving sophisticated insights into campaign performance without needing to provide one tenant with access to another tenant's private data. In addition, one or more embodiments can address anomalies quickly, in some cases without requiring user input, while simultaneously continuing to monitor for additional anomalies.

One or more embodiments can detect “good” anomalies and/or “bad” anomalies. As used herein, a “good” anomaly is an anomaly associated with a desirable performance outcome for a campaign. For example, a good anomaly may indicate a particularly high open rate, high click rate, high lead rate, high conversion rate, high sales volume, fast load time (e.g., for a campaign landing page), fast delivery time (e.g., for emails or text messages), etc. As used herein, a “bad” anomaly is an anomaly associated with an undesirable performance outcome for a campaign. For example, a bad anomaly may indicate a particularly low open rate, low click rate, low lead rate, low conversion rate, low sales volume, slow load time (e.g., for a campaign landing page), slow delivery time (e.g., for emails or text messages), etc. Good anomalies may indicate opportunities to adjust a campaign to increase the occurrence of such anomalies, and bad anomalies may indicate opportunities to adjust a campaign to decrease the occurrence of such anomalies. As described herein, an anomaly may be defined in relation to a baseline value or range of values; for example, as described in further detail below, an anomaly may be relative to a threshold value for a performance metric. Thus, both good and bad anomalies may supply information that can be used to increase overall campaign performance.

One or more embodiments described in this Specification and/or recited in the claims may not be included in this General Overview section.

### 2. EXAMPLE SYSTEM

### 2.1. System Components

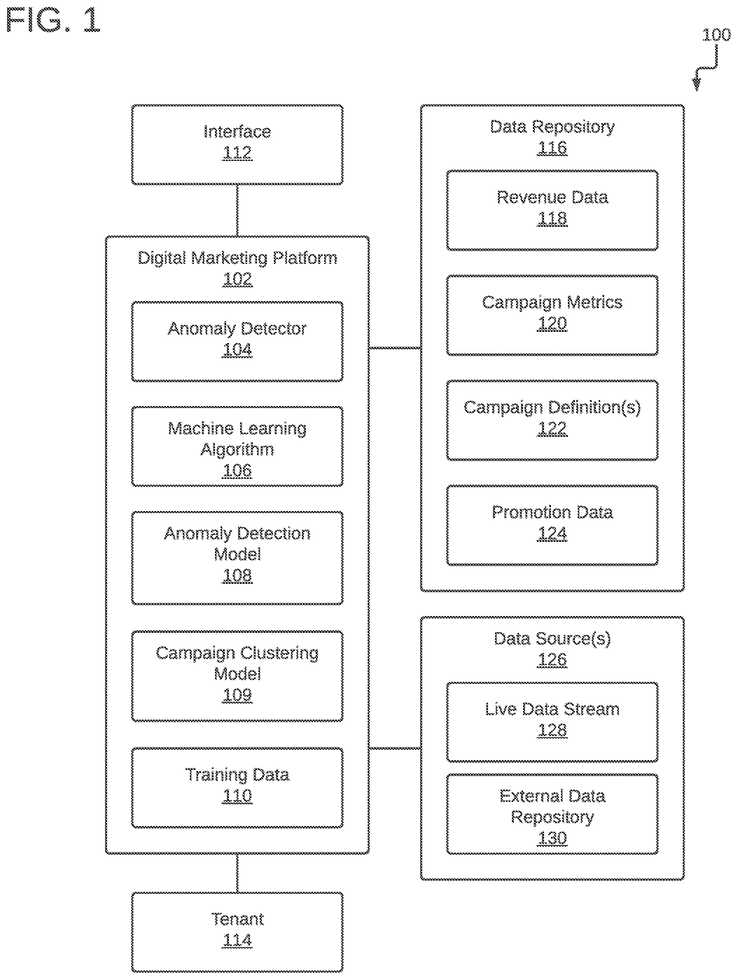

FIG. 1 illustrates an example of a system 100 in accordance with one or more embodiments. As illustrated in FIG. 1, the system 100 includes an interface 112, a digital marketing platform 102, a data repository 116, one or more tenants 114, and components thereof. In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in the section titled “Computer Networks and Cloud Networks.”

A digital marketing platform 102 is a set of hardware and/or software used to manage one or more digital marketing campaigns. Campaign management features may include one or more of: creating new campaigns; monitoring campaign performance; modifying existing campaigns; comparing one campaign's performance with another's, etc.

The digital marketing platform 102 includes an anomaly detector 104. An anomaly detector 104 refers to hardware and/or software configured to perform operations described herein for detecting anomalies in live marketing campaign data. As used herein, “live” means that the data is obtained in real-time, i.e., transmitted to the digital marketing platform 102 as it is collected. Live digital marketing data may include data that describes views, clicks, leads, conversions to sales, and/or any other kind of information that describes interactions with a campaign. Some examples of operations for performing anomaly detection in live marketing campaign data are described in further detail below.

An anomaly detection model 108 refers to a set of hardware and/or software configured to receive a set of digital marketing data and determine whether the set includes any anomalies. As used herein, an “anomaly” refers to data that is not in the expected format and/or that otherwise deviates significantly from a baseline expectation. An anomaly may be “good,” meaning that it indicates campaign performance that exceeds the baseline expectation in at least one instance, or it may be “bad,” indicating that the data is malformed and/or indicates campaign performance that falls short of the baseline expectation in at least one instance. The anomaly detection model 108 may include one or more machine learning models and/or one or more anomaly detection rules. Some examples of machine learning techniques are described in further detail below.

As noted above, an anomaly detection model 108 may include one or more anomaly detection rules. In general, an anomaly detection rule specifies one or more criteria for evaluating whether digital marketing data is anomalous. An anomaly detection rule may include a set of code with one or more variables corresponding to anomaly threshold(s), a regular expression, a heuristic, and/or another kind of rule or combination thereof.

When applied to a set of digital marketing data, the anomaly detection rule determines whether any of the data is anomalous according to the one or more criteria. For example:
An anomaly detection rule may be based, at least in part, on one or more user-specified performance metrics. For a given performance metric, a user may specify one or more threshold values corresponding to anomalous performance. The anomaly detection model(s) 108 may include one or more rules that incorporate(s) the user-specified threshold value such that, when applied to a particular set of digital marketing data, the anomaly detection model 108 determines whether any of the digital marketing data satisfies the threshold value.
An anomaly detection rule may be based, at least in part, on the output of one or more machine learning models. A machine learning model may be trained to identify a cluster of similar campaigns and determine one or more baseline performance metrics for the cluster of similar campaigns. The anomaly detector 104 may be configured to use the machine-learning-derived performance metric(s) to configure an anomaly detection rule. For example, an anomaly detection rule may include upper and lower thresholds based on a machine-learning-derived range of click, lead, and/or conversion rates for similar campaigns.
An anomaly detection rule may be based, at least in part, on a baseline data schema. A user and/or computer process may specify an expected data schema for digital marketing data. For example, the baseline data schema may specify one or more required fields, expected data types for each field, ranges of expected values for each field, etc. When applied to a particular set of digital marketing data, the anomaly detection model 108 determines whether any of the data fails to satisfy the baseline data schema.

The anomaly detector 104 may be configured to perform anomaly detection for marketing campaign data obtained from one or more data sources 126. The data source(s) 126 may include one or more live data streams 128. A live data stream 128 refers to a stream of data that is obtained in real-time, i.e., transmitted to the digital marketing platform 102 as it is collected. For example, a live data stream 128 may include data indicating interactions with one or more digital marketing materials, such as opens, clicks, leads, conversions, purchases, etc. In general, the live data stream 128 may include data that corresponds to one or more performance metrics associated with a digital marketing campaign. Alternatively or additionally, the digital marketing platform 102 may be configured to obtain data from an external data repository 130, which may not be configured to supply data in real time. For example, as described in further detail herein, the digital marketing platform 102 may be configured to ingest an existing, aggregated set of digital campaign data stored in an external data repository 130 and perform anomaly detection on that data.

The digital marketing platform 102 may be configured to store and/or retrieve data in a data repository 116. Data stored in the data repository 116 may include revenue data 118, campaign metrics 120, one or more campaign definitions 122, promotion data 124, and/or other kinds of data associated with one or more digital marketing campaigns. Some examples of a data repository 116 and data that may be stored therein are described in further detail below.

In one or more embodiments, one or more components of the system 100 are implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (PDA), a wireless receiver and/or transmitter, a base station, a communication management device, a router, a switch, a controller, an access point, and/or a client device.

### 2.2. Data Storage

In one or more embodiments, a data repository 116 is any type of storage unit and/or device (e.g., a file system, database, collection of tables, and/or any other storage mechanism) for storing data. As illustrated in FIG. 1, the data repository 116 may be configured to store revenue data 118, campaign metrics 120, one or more campaign definitions 122, and/or promotion data 124.

In an embodiment, data stored in the data repository 116 includes data obtained from one or more data sources 126 as described herein. Before storing data from a data source 126 in the data repository 116, the digital marketing platform 102 may be configured to normalize, aggregate, and/or otherwise transform the data into a format that is more suitable for storage and processing by the digital marketing platform 102. The platform 102 may be configured to apply one or more user-defined transformations to the data. User-defined transformation may include data cleansing (e.g., detecting and correcting corrupt or inaccurate records) and/or generating one or more custom attributes (e.g., by aggregating multiple records, formatting data fields, etc.). For example, a user may instruct the platform 102 to drop missing values from data and/or drop outliers (detected as described herein and/or using other techniques) to obtain clean, transformed data.

Revenue data 118 includes data that describes revenue generated by one or more digital marketing campaigns. For example, when somebody follows a link in a social media advertisement and purchases a product, the revenue data 118 may identify the campaign, the product, and/or the price paid for the product. Revenue data 118 may also include information about the person who purchased the product, such as demographic information associated with the person's social media profile. In general, revenue data 118 may include any kind of information that associates a digital marketing campaign with revenue generated by that campaign.

Campaign metrics 120 include metrics associated with digital marketing campaigns. For example, campaign metrics 120 may include metrics associated with clicks, leads, conversions, etc. associated with one or more campaigns. The platform 102 may be configured to generate the campaign metrics 120 based on data received from one or more data sources, and detect anomalies based on the campaign metrics 120, instead of—or in addition to—the raw marketing data in the format in which it is received. In an embodiment, the platform 102 is configured to generate the campaign metrics 120 on an ongoing basis, as the digital marketing data is received and while the campaign is still executing.

The anomaly detector 104 may configure an anomaly detection model 108 based on campaign metrics 120. If the campaign metrics 120 are associated with multiple campaigns for multiple tenants, the campaign metrics 120 may be anonymized. Anonymizing the campaign metrics 120 allows a tenant to improve marketing strategies based on information gleaned from other tenants' campaigns, without requiring the other tenants to disclose proprietary information.

A campaign definition 122 includes data that defines a particular digital marketing campaign. For example, a campaign definition 122 may include one or more images, text, links, prices, start date and/or condition, end date and/or condition, and/or other data that defines one or more parameters of the particular campaign. The anomaly detector 104 may be configured to modify a campaign definition 122, responsive to user input and/or without requiring user input, to address one or more anomalies in digital marketing data associated with that campaign. If the anomaly is a good anomaly, the anomaly detector 104 may be configured to modify the campaign definition 122 in a manner that seeks to increase the frequency of such anomalies. If the anomaly is a bad anomaly, the anomaly detector 104 may be configured to modify the campaign definition 122 in a manner that seeks to reduce the frequency of such anomalies.

Promotion data 124 includes data that defines one or more promotional offers (e.g., a discount, promotional code, reduced price, bundle deal, etc.). Promotion data 124 may be associated with a particular campaign or multiple campaigns. A campaign definition 122 may reference promotion data 124 to indicate that the particular campaign uses a particular promotion defined in the promotion data 124.

The data repository 116 may include multiple different storage units and/or devices. The multiple different storage units and/or devices may or may not be of the same type or located at the same physical site. The data repository 116 may be implemented or executed on the same computing system as the digital marketing platform 102, and/or on a computing system separate from the digital marketing platform 102. The data repository 116 may be communicatively coupled to the digital marketing platform 102 via a direct connection or via a network. Information describing revenue data 118, campaign metrics 120, campaign definitions 122, and/or promotion data 124 may be implemented across any of the components of the system 100. However, this information is illustrated within the data repository 116 for purposes of clarity and explanation.

### 2.3. User Interface

In one or more embodiments, an interface 112 refers to hardware and/or software configured to facilitate communications between a user and the digital marketing platform 102. The interface 112 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. Different components of the interface 112 may be specified in different languages. For example, the behavior of user interface elements may be specified in a dynamic programming language, such as JavaScript. The content of user interface elements may be specified in a markup language, such as hypertext markup language (HTML) or XML User Interface Language (XUL). The layout of user interface elements may be specified in a style sheet language, such as Cascading Style Sheets (CSS). Alternatively, the interface 112 may be specified in one or more other languages, such as Java, Python, C, or C++.

### 2.4. Tenants

In one or more embodiments, a tenant 114 is a corporation, organization, enterprise, or other entity that accesses a shared computing resource, such as the digital marketing platform 102. The system 100 may include multiple tenants 114 that are independent from each other, such that a business or operation of one tenant is separate from a business or operation of another tenant. Some examples of multi-tenant architectures in accordance with one or more embodiments are described in further detail below.

The anomaly detector 104 may be configured to detect anomalies in digital marketing data for multiple tenants independently, i.e., without commingling data from the different tenants. For example, the anomaly detector 104 may configure an anomaly detection model 108 based on historical data associated only with a particular tenant. Isolating each tenant's data in a multi-tenant environment helps protect the privacy and security of each tenant's respective data.

Alternatively or additionally, the anomaly detector 104 may be configured to detect anomalies in digital marketing data for multiple tenants collectively, i.e., using data from multiple tenants. To help protect the privacy and security of each tenant's data, the data may be anonymized before aggregating or otherwise combining it. For example, training data 110 may include anonymized data from prior digital marketing campaigns associated with different tenants. Using data from multiple tenants may improve the quality of campaign clustering and/or anomaly detection, compared with relying on data associated only with a single tenant. Even when using data from multiple tenants, each tenant 114 may use its own respective anomaly detection model 108. Keeping separate anomaly detection models 108 may allow for each model to adapt, over time, to the specific needs of each tenant.

### 2.5. Machine Learning

As discussed above, the anomaly detector 104 may be configured to use one or more machine learning models to obtain baseline data for detecting anomalies (e.g., using a campaign clustering model 109) and/or to detect anomalies in new data (e.g., using an anomaly detection model 108).

In general, a machine learning algorithm 106 is an algorithm that can be iterated to learn a target model (e.g., an anomaly detection model 108 or a campaign clustering model 109) that best maps a set of input variables to one or more output variables, using a set of training data 110. The training data 110 includes datasets and associated labels. The datasets are associated with input variables for the target model. The associated labels are associated with the output variable(s) of the target model.

A label associated with a dataset in the training data 110 may indicate, for each item in the dataset, whether that item is anomalous. If an item in the dataset is anomalous, another label may include a score corresponding to a severity of the anomaly. Alternatively or additionally, the score itself may indicate whether the item is anomalous. The training data 110 may be updated based on, for example, feedback on the accuracy of the current anomaly detection model 108. Updated training data that describes newly detected anomalies may be fed back into the machine learning algorithm 106, which may in turn update the anomaly detection model 108. Data that describes anomalies may include, for example, one or more of: date and time of detection; a title/name of the anomaly; severity (e.g., warning or error); anomaly description; an action taken to address the anomaly; severity score; associated log data; and/or information about the tenant whose data included the anomaly (e.g., a user identifier).

Alternatively or additionally, a label associated with a dataset in the training data 110 may indicate, for each item in the dataset, values of one or more criteria for clustering similar campaigns (e.g., industry, campaign type, etc.). The training data 110 may be updated based on, for example, feedback on the accuracy of the campaign clustering model 109. Updated training data associated with similar campaigns may be fed back into the machine learning algorithm 106, which may in turn update the campaign clustering model 109.

The machine learning algorithm 106 may generate the target model such that the target model best fits the datasets of the training data 110 to the labels of the training data 110. Specifically, the machine learning algorithm 106 may generate the target model such that when the target model is applied to the datasets of the training data 110, a maximum number of results determined by the target model match the labels of the training data 110. Different target models be generated based on different machine learning algorithms and/or different sets of training data.

The machine learning algorithm 106 may include supervised components and/or unsupervised components. Various types of algorithms may be used, such as linear regression, logistic regression, linear discriminant analysis, classification and regression trees, naïve Bayes, k-nearest neighbors, learning vector quantization, support vector machine, bagging and random forest, boosting, backpropagation, and/or clustering.

### 3. DETECTING ANOMALIES IN LIVE MARKETING CAMPAIGN DATA

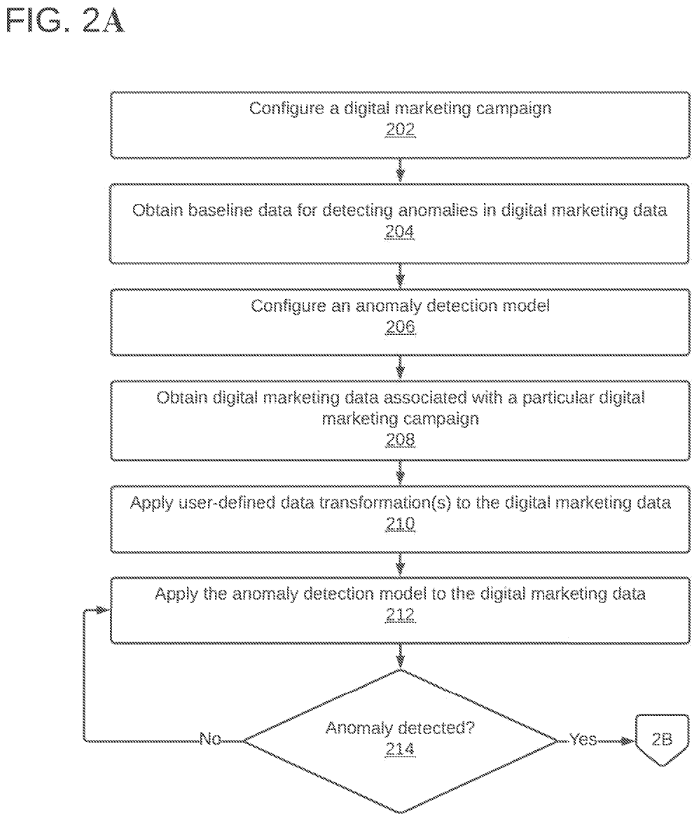

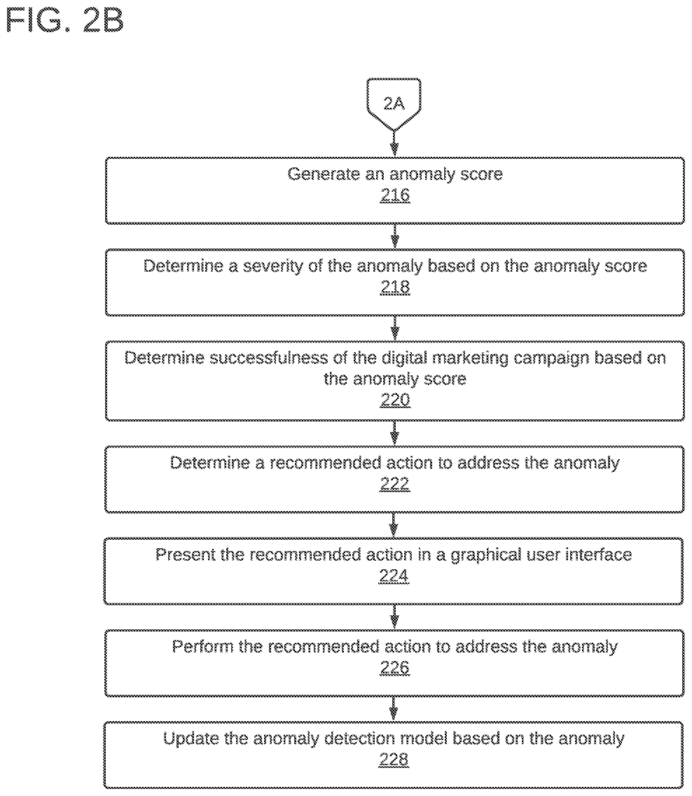

FIGS. 2A-2B illustrate an example set of operations for detecting anomalies in live marketing campaign data in accordance with one or more embodiments. One or more operations illustrated in FIGS. 2A-2B may be modified, rearranged, or omitted all together. Accordingly, the particular sequence of operations illustrated in FIGS. 2A-2B should not be construed as limiting the scope of one or more embodiments.

### 3.1. Configuring a Digital Marketing Campaign

In an embodiment, a digital marketing platform configures a digital marketing campaign (Operation 202). To configure the campaign, the platform may receive user input corresponding to one or more parameters of a campaign definition. Responsive to receiving the user input, the platform may store the campaign definition with the provided value(s). The platform may further receive user input to start the campaign. Starting the campaign brings the campaign “live.” For example, if the campaign is a social media campaign, starting the campaign instructs the platform to start publishing the designated marketing content on the designated social media sites(s). If the campaign is an email campaign, starting the campaign instructs the platform to start sending emails according to the campaign definition. In general, starting the campaign instructs the platform to start publishing marketing content and track interactions with the marketing content (e.g., by tracking views, clicks, leads, conversions, etc.). One or more embodiments described herein are configured to detect anomalies in a live stream of digital marketing data, while the campaign is still live. The system is not required to pause or terminate the campaign in order to evaluate the digital marketing data and identify anomalies.

### 3.2. Obtaining Baseline Data

In an embodiment, the platform obtains baseline data for detecting anomalies in digital marketing data (Operation 204). As described above, the platform may obtain baseline data in various ways depending, at least in part, on the type of anomaly sought to be detected. For example:
The platform may obtain historical data associated with one or more campaigns, which may be associated with a single tenant or multiple tenants.
The platform may use machine learning to cluster data from similar campaigns and determine one or more baseline performance metrics associated with the similar campaigns.
The platform may obtain a baseline data schema associated with one or more campaigns.
The platform may obtain one or more user-specified threshold values for one or more performance metrics, indicating one or more boundaries of anomalous performance. For example, a user may supply, via a user interface, a value of a performance metric indicating a lower threshold for non-anomalous performance and/or a value of a performance metric indicating an upper threshold for non-anomalous performance. The user-specific value(s) may thus correspond to a benchmark value or range of values for detecting anomalies.

### 3.3. Configuring an Anomaly Detection Model

In an embodiment, the platform configures an anomaly detection model (Operation 206). In general, given a set of digital marketing data, an anomaly detection model determines whether the data includes any anomalies, i.e., data items that deviate significantly from the baseline data. As described above, the platform may configure the anomaly detection model in various ways. The platform may train a machine learning model to detect anomalies in digital marketing data, using baseline data that includes historical campaign data associated with one or more tenants. The platform may train the machine learning mode on an ongoing basis, based on live streamed data associated with one or more digital marketing campaigns. For example, the platform may receive digital marketing data from multiple campaigns on an ongoing basis, including data that describes detected anomalies. The platform may update the machine learning model using supervised, semi-supervised, or unsupervised learning based on the live data, so that the machine learning model continues to reflect shifts in baseline performance across the multiple campaigns.

Alternatively or additionally, the platform may configure a set of one or more anomaly detection rules, based at least in part on one or more machine-learning-derived and/or user-specified baseline performance metrics. The platform may update the anomaly detection rule(s) on an ongoing basis, based on live streamed data associated with one or more digital marketing campaigns. For example, the platform may receive digital marketing data from multiple campaigns on an ongoing basis, including data that describes detected anomalies. The platform may update the anomaly detection rule(s) based on the live data, so that the rule(s) continue(s) to reflect shifts in baseline performance across the multiple campaigns.

### 3.4. Obtaining Digital Marketing Data

In an embodiment, the platform obtains digital marketing data associated with the campaign (Operation 208). To obtain the digital marketing data, the platform may receive a live stream of digital marketing data. For example, when a user clicks on an advertisement in a web browser, the advertisement may include a tracking uniform resource locator (URL). The tracking URL may direct the user to a site that collects campaign data and either displays the requested content or redirects the user to another site that displays the requested content. The tracking URL may be hosted by the digital marketing platform itself, or by another service that subsequently transmits the campaign data to the platform.

Alternatively or additionally, the platform may obtain data from a non-live source. For example, a tenant of the platform may host a set of historical campaign data in a data repository that is external to the platform. The platform may obtain the historical data from the external data repository.

The platform may apply one or more user-defined transformations to the digital marketing data (Operation 210). In general, a transformation modifies the incoming data so that it matches a format expected by the anomaly detection model. For example, a transformation may rename a field, change a data type of the field, store field values in a particular type of data structure, etc. A user-defined transformation may aggregate data based on data types, e.g., “email link clicked,” “email replied to,” etc. Alternatively or additionally, a user-defined transformation may generate a micro-segmentation of the consumer base, e.g., based on one or more consumer attributes that are discernible from the data.

### 3.5. Detecting and Scoring Anomalies

In an embodiment, the platform applies the anomaly detection model to the digital marketing data (Operation 212). If the anomaly detection model includes one or more anomaly detection rules, the platform may apply the rule(s) to the data, to determine if the data includes any anomalies. Alternatively or additionally, if the anomaly detection model includes a machine learning model, the platform may apply the machine learning model to the data, to determine if the data includes any anomalies. The platform may not apply the anomaly detection model to the campaign data directly; instead, the platform may apply the anomaly detection model to a data source view (DSV) of the data.

The platform may continue to apply the anomaly detection model to digital marketing data as it is received. Based on the output of the anomaly detection model, the platform determines whether an anomaly was detected (Operation 214). The output may include a yes/no, Boolean, and/or other kind of value that indicates whether a data item is anomalous.

Alternatively or additionally, the platform may generate an anomaly score (Operation 216) as output of the anomaly detection model and/or by post-processing the output of the anomaly detection model. A particular value or range of values may be considered non-anomalous, such that values outside of the non-anomalous range/value in one direction are good anomalies and values outside of the non-anomalous range/value in the other direction are bad anomalies. Based on the anomaly score, the platform may determine the anomaly's severity (Operation 218). The severity of an anomaly may increase as its score deviates further from a non-anomalous range.

Based on one or more anomaly scores, the platform may determine successfulness of the digital marketing campaign (Operation 220). For example, given a set of anomaly scores for campaign data over a period of time, the platform may determine whether the scores tend to be favorable or unfavorable. A large number of good anomalies, and/or anomalies that deviate significantly from the baseline in the “good” direction, may indicate a particularly successful campaign. A large number of bad anomalies, and/or anomalies that deviate significantly from the baseline in a “bad” direction, may indicate a particularly unsuccessful campaign.

If an anomaly was detected, the platform may process the anomaly as described below. The platform may continue to detect anomalies in incoming digital marketing data, even as it addresses an anomaly that was already detected. The platform is not required to pause or terminate anomaly detection in order to address an anomaly.

### 3.6. Addressing Anomalies

Responsive to detecting one or more anomalies, the platform may determine a recommended action to address the one or more anomalies (Operation 222). For example:
If an anomaly is a good anomaly, or a campaign demonstrates a large number of good anomalies, the recommended action may be to modify the campaign accordingly to increase the occurrence of such anomalies. As one example, if good anomalies tend to occur in interactions with users in a particular demographic, the recommended action may be to target more users in that demographic. As another example, if good anomalies tend to occur at particular times of day, the recommended action may be to increase marketing spend during those times of day. As still another example, if good anomalies are associated with a particular marketing platform, the recommended action may be to increase marketing spend on that platform.
If an anomaly is a bad anomaly, or a campaign demonstrates a large number of bad anomalies, the recommended action may be to modify the campaign accordingly to decrease the occurrence of such anomalies. As one example, if bad anomalies tend to occur in interactions with users in a particular demographic, the recommended action may be to target fewer users in that demographic. As another example, if bad anomalies tend to occur at particular times of day, the recommended action may be to decrease marketing spend during those times of day. As still another example, if bad anomalies are associated with a particular marketing platform, the recommended action may be to decrease marketing spend on that platform.
If an anomaly indicates that data does not satisfy a baseline data schema, the recommended action may be to investigate the source of the data to determine a root cause of the malformed data.
The platform may generate a micro-segmentation of the prospective customer base, based on anomalies detected in connection with a particular demographic. The platform may analyze data associated with good anomalies, to determine whether any demographic attributes tend to predict the good anomalies. Alternatively or additionally, the platform may analyze data associated with bad anomalies, to determine whether any demographic attributes tend to predict the bad anomalies. Depending on whether the anomaly is a good anomaly or a bad anomaly, the platform may recommend either increasing or decreasing marketing efforts directed toward the micro-segmentation associated with the anomaly. To avoid targeting individual users, the platform may only generate a micro-segmentation if it would include a sufficient number of members (e.g., one thousand or more) within the identified demographic, and/or if one or more other criteria is/are satisfied. For example, the platform may identify a micro-segmentation of at least 1,000 users who have had at least 24 hours to respond to a particular set of marketing material, and whose collective conversion rate is anomalously good or bad. A micro-segmentation may identify a pattern associated with an anomaly that would not be readily discernible to a human operator, such as properties of the user's computer system and/or other technical details that are generally not readily discernible to a human operator. Techniques described herein may thus allow for finer tuning of campaign targeting than what would be possible otherwise.
Responsive to detecting one or more bad anomalies, the platform may terminate the digital marketing campaign. Terminating the campaign responsive to detecting bad anomalies may help avoid expending money and/or computing resources on campaigns that are not performing sufficiently well.

The platform may present the recommended action in a graphical user interface (GUI) (224). Some examples of graphical user interfaces are described below. Alternatively or additionally, the platform may transmit an alert via email, a messaging platform (e.g., Slack, Asana, etc.), text message, etc. The platform may receive, via the GUI or other interface, user input that instructs the platform to perform the recommended action. Responsive to the user input, the platform may perform the recommended action to address the anomaly (Operation 226). Alternatively, the platform may not require user input to perform the recommended action; the platform may perform the recommended action without waiting for user input. Without requiring user input/approval, the platform may transmit one or more commands (e.g., to a social media platform and/or other platform on which the campaign is executing) to pause execution of the campaign, modify a configuration of the campaign, and/or resume execution of the campaign subsequent to modification.

The platform may be configured to require user input to perform some recommended actions but not others. For example, the platform may require user input if an anomaly is particularly severe, i.e., its severity exceeds a maximum threshold for the platform to perform the recommended action without user input. If the anomaly is less severe, the platform may perform the recommended action without requiring a user instruction to do so.

### 3.7. Updating the Anomaly Detection Model

In an embodiment, the platform updates the anomaly detection model based on the anomaly (Operation 228). If the anomaly detection model includes a machine learning model, the platform may feed data that describes the anomaly back into the machine learning model, to help improve the machine learning model's ability to detect such anomalies. If the anomaly detection model includes an anomaly detection rule, the platform may adjust one or more variables' value(s) in the rule, to help improve the rule's ability to detect such anomalies.

### 4. EXAMPLE EMBODIMENTS

Detailed examples are described below for purposes of clarity. Components and/or operations described below should be understood as specific examples which may not be applicable to certain embodiments. Accordingly, components and/or operations described below should not be construed as limiting the scope of any of the claims.

### 4.1. Example Use Cases

4.1.1. Detecting Anomalies in a Data Import

In this example, a tenant seeks to import or ingest historical campaign data from an external data repository. The campaign data includes records stored in Customer, Event, and Order tables. As part of the import, the tenant seeks to identify any anomalies in the data. To detect anomalies, the tenant may specify a data schema that includes expected fields, field types, and field values for the Customer, Event, and Order tables. For example, the Event table may require eleven (11) default relationships that are specified in the data schema. The Order table may require five (5) default relationships that are specified in the data schema. Based on the baseline data schema, the platform configures a set of rules for detecting anomalies in the ingested data.

As part of the ingestion process, the platform may provide a “run anomaly detection” control that, when selected by a user, performs anomaly detection on the ingested data. The user may be able to select what kinds of anomalies to detect (e.g., detect garbage values but ignore null values). Alternatively, the platform may perform anomaly detection without prompting. If the ingested data does not satisfy the rules, i.e., does not match the baseline data schema, the platform may generate an alert and/or perform an action to address the anomaly (e.g., by changing a data type, inserting a default value in a field, etc.).

4.1.2. Detecting Anomalies in Time Series Data

In this example, a tenant seeks to generate an aggregate data attribute, based on a combination of two or more other attributes in the digital marketing data. Before generating the attribute, the tenant wants to know if the attributes to be aggregated include any anomalies. The tenant may define a query directed to a data source view (DSV) of the underlying campaign data. The query is configured to retrieve the attributes to be aggregated, including data from the Order table, which includes time-series based values. The platform may detect anomalies in the Order table, such as (1) an order identifier (OrderID) populated without a valid purchase price (OrderTotal) (e.g., one or more values may be missing, null, garbage, or otherwise incorrect) for one or more customer identifiers (CustomerID), or (2) an OrderID not linked to a correct product identifier (OrderItemID) for one or more CustomerIDs.

4.1.3. Detecting Outliers in Campaign Metrics

In this example, a tenant seeks to detect outliers in campaign metrics, i.e., instances of particularly good or bad performance. Detecting good or bad performance allows for fine-tuning the campaign, to increase the occurrence of good performance and/or decrease the occurrence of bad performance. Based on the campaign data, including audience information and behavioral data such as click rate, open rate, conversion rate, etc., the platform can detect outliers and measure campaign performance overall. The platform may further store information about the outliers and use the information to improve anomaly detection going forward (e.g., by updating an anomaly detection model).

### 4.2. Example User Interfaces

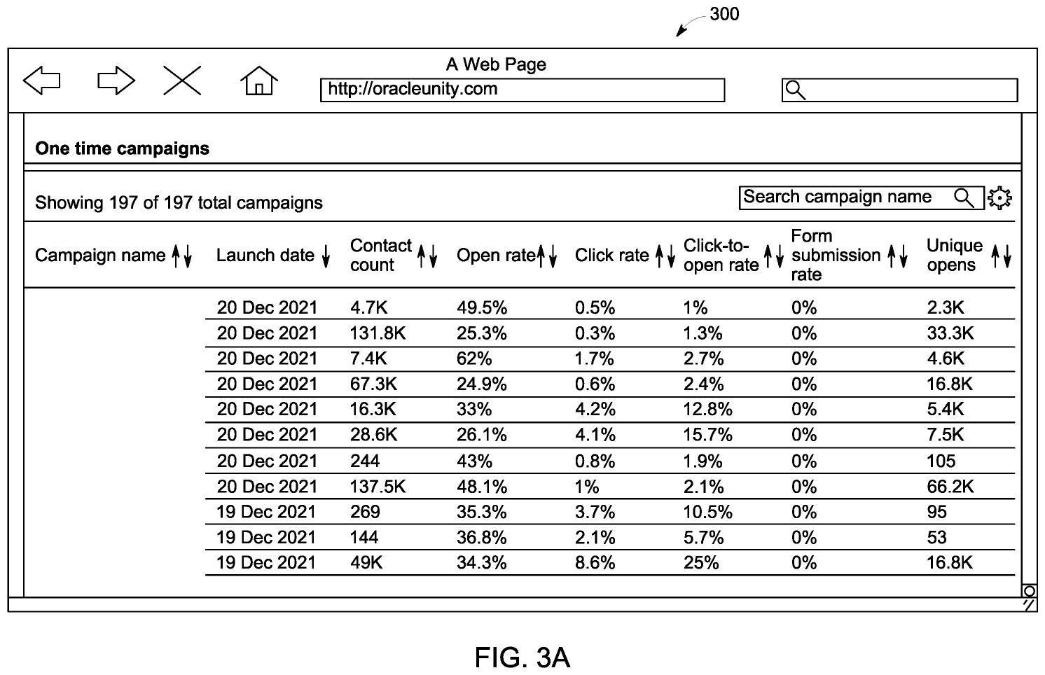

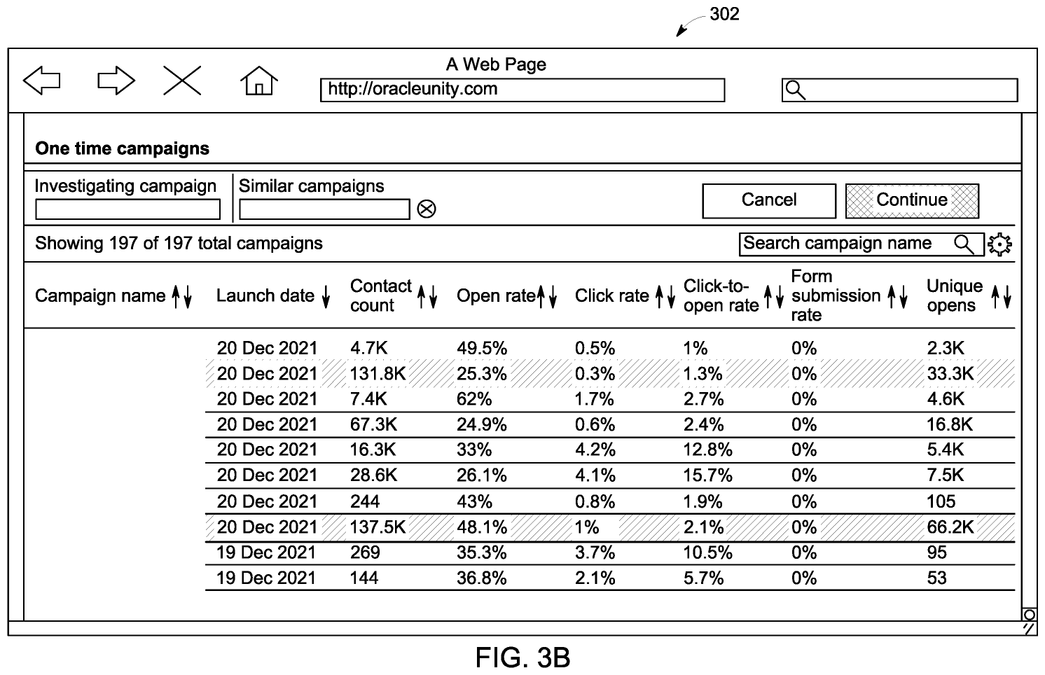

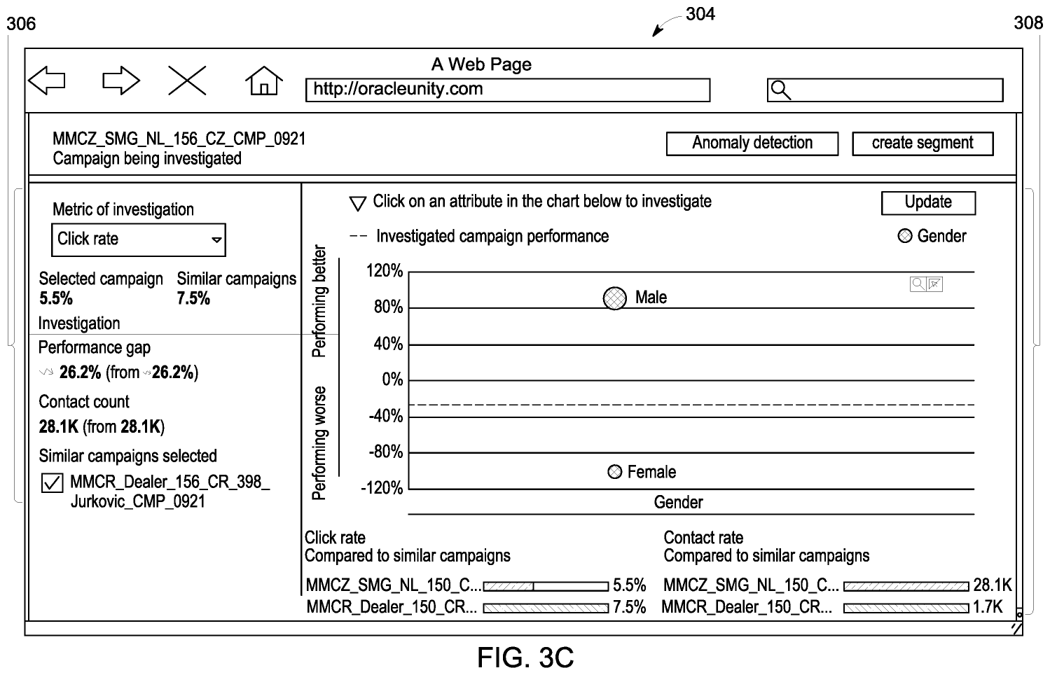

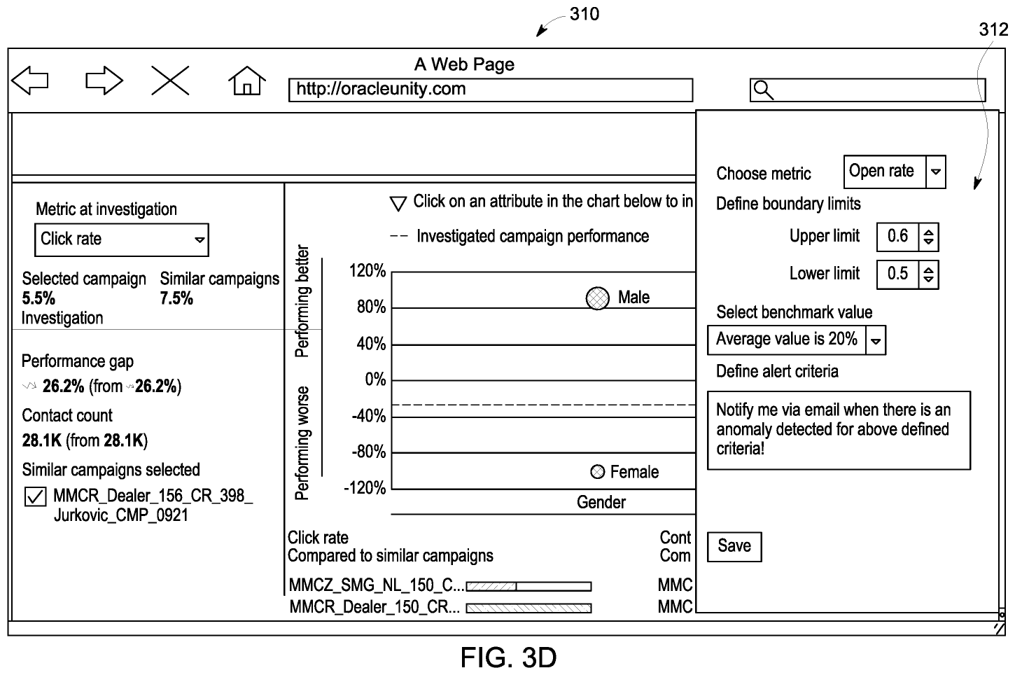

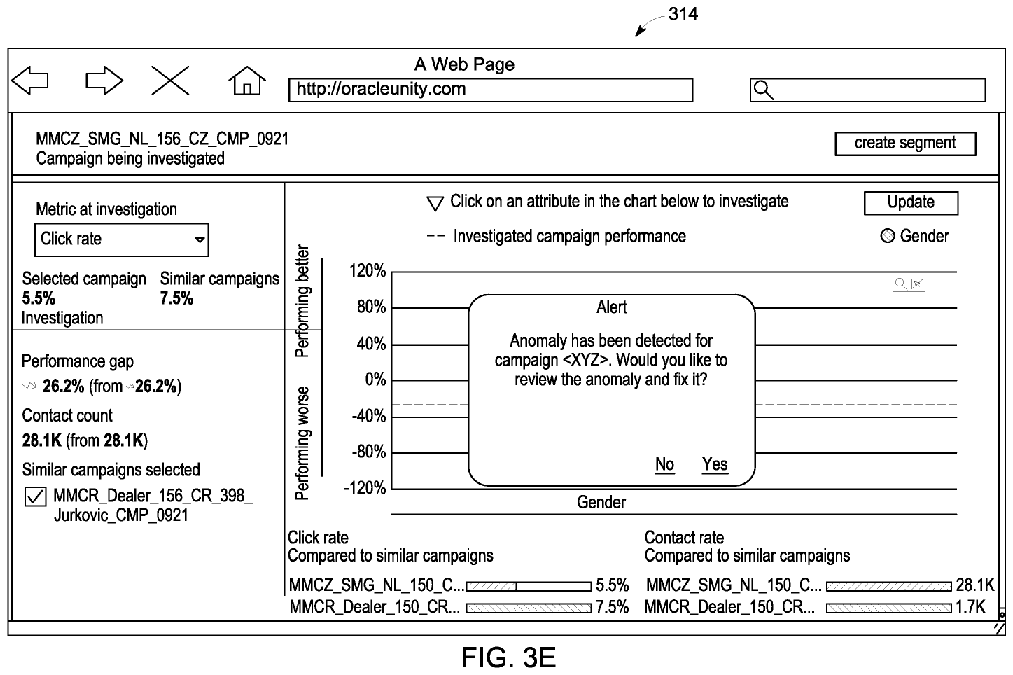

FIGS. 3A-3E illustrate examples of graphical user interfaces (GUIs) for a digital marketing platform in accordance with one or more embodiments.

FIG. 3A illustrates an example of a GUI 300 that presents performance metrics based on digital marketing data associated with multiple digital marketing campaigns. In this example, the metrics include, for each campaign: launch data, contact count, open rate, click rate, click-to-open rate, form submission rate, and unique opens. In general, performance metrics presented in the GUI 300 may include one or more of: bounce rate, click rate, click-to-open rate, delivery rate, engaged contacts, form submission rate, open rate, page views, productive clicks, subscribed, total clicks, total completed forms, total delivered, unique clicks, unique opens, unsubscribed, web visitors, web visits, and/or other kinds of metrics associated with a digital marketing campaign.

FIG. 3B illustrates an example of a GUI 302 in which two similar campaigns are highlighted. In an embodiment, the platform is configured to identify similar campaigns and highlight them in the GUI 302, so that a marketer can more easily compare the similar campaigns.

FIG. 3C illustrates an example of a GUI 304 that compares a particular campaign with one or more similar campaigns. Performance metrics 306 indicate how the campaign's performance metrics compare with the other campaign(s). In this example, the current campaign's click rate underperforms a similar campaign by 26.2%. Performance metric details 308 provide more granular information, so that a marketer can investigate the campaign's performance relative to the similar campaign(s). In this example, the performance metric details 308 indicate significantly better performance among male recipients than female recipients.

FIG. 3D illustrates an example of a GUI 310 for configuring an anomaly detection rule. The GUI 310 includes controls 312 for configuring the values of variables that correspond to parameters of the anomaly detection rule. The variables include which metric to evaluate for anomalies, a baseline or benchmark value for comparison (in this example, a platform-supplied average based on similar campaigns), upper and lower limits of a non-anomalous range (in this example, 0.6% above baseline or 0.5% below baseline), and alert criteria.

FIG. 3E illustrates an example of a GUI 314 that presents an alert when an anomaly is detected. Responsive to receiving the alert, a marketer may elect to ignore the anomaly or view details about the anomaly and optionally instruct the platform to take a recommended action. Alternatively or additionally, as described above, the platform may be configured to address an anomaly without requiring user input.

### 5. COMPUTER NETWORKS AND CLOUD NETWORKS

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service, such as execution of a particular application and/or storage of a particular amount of data). A server process responds by, for example, executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, or a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network, such as a physical network. Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

A client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (for example, a web browser), a program interface, or an application programming interface (API).

In one or more embodiments, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In one or more embodiments, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider's applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

A computer network may implement various deployment, including but not limited to a private cloud, a public cloud, and/or a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof may be accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In one or more embodiments, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In a multi-tenant computer network, tenant isolation may be implemented to ensure that the applications and/or data of different tenants are not shared with each other. Various tenant isolation approaches may be used. Each tenant may be associated with a tenant identifier (ID). Each network resource of the multi-tenant computer network may be tagged with a tenant ID. A tenant may be permitted access to a particular network resource only if the tenant and the particular network resources are associated with the same tenant ID.

For example, each application implemented by the computer network may be tagged with a tenant ID, and tenant may be permitted access to a particular application only if the tenant and the particular application are associated with a same tenant ID. Each data structure and/or dataset stored by the computer network may be tagged with a tenant ID, and tenant may be permitted access to a particular data structure and/or dataset only if the tenant and the particular data structure and/or dataset are associated with a same tenant ID. Each database implemented by the computer network may be tagged with a tenant ID, and tenant may be permitted access to data of a particular database only if the tenant and the particular database are associated with the same tenant ID. Each entry in a database implemented by a multi-tenant computer network may be tagged with a tenant ID, and a tenant may be permitted access to a particular entry only if the tenant and the particular entry are associated with the same tenant ID. However, the database may be shared by multiple tenants.

In one or more embodiments, a subscription list indicates which tenants have authorization to access which network resources. For each network resource, a list of tenant IDs of tenants authorized to access the network resource may be stored. A tenant may be permitted access to a particular network resource only if the tenant ID of the tenant is included in the subscription list corresponding to the particular network resource.

In one or more embodiments, network resources (such as digital devices, virtual machines, application instances, and threads) corresponding to different tenants are isolated to tenant-specific overlay networks maintained by the multi-tenant computer network. As an example, packets from any source device in a tenant overlay network may be transmitted only to other devices within the same tenant overlay network. Encapsulation tunnels may be used to prohibit any transmissions from a source device on a tenant overlay network to devices in other tenant overlay networks. Specifically, packets received from the source device may be encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

6. MICROSERVICE APPLICATIONS

In one or more embodiments, techniques described herein are implemented in a microservice architecture. A microservice in this context refers to software logic designed to be independently deployable, having endpoints that may be logically coupled to other microservices to build a variety of applications. Applications built using microservices are distinct from monolithic applications, which are designed as a single fixed unit and generally include a single logical executable. With microservice applications, different microservices are independently deployable as separate executables. Microservices may communicate using Hypertext Transfer Protocol (HTTP) messages and/or according to other communication protocols via Application Programming Interface (API) endpoints. Microservices may be managed and updated separately, written in different languages, and executed independently from other microservices.

Microservices provide flexibility in managing and building applications. Different applications may be built by connecting different sets of microservices without changing the source code of the microservices. Thus, the microservices act as logical building blocks that may be arranged in a variety of ways to build different applications. Microservices may provide monitoring services that notify a microservices manager (such as If-This-Then-That (IFTTT), Zapier, or Oracle Self-Service Automation (OSSA)) when trigger events from a set of trigger events exposed to the microservices manager occur. Microservices exposed for an application may alternatively or additionally provide action services that perform an action in the application (controllable and configurable via the microservices manager by passing in values, connecting the actions to other triggers and/or data passed along from other actions in the microservices manager) based on data received from the microservices manager. The microservice triggers and/or actions may be chained together to form recipes of actions that occur in optionally different applications that are otherwise unaware of or have no control or dependency on each other. These managed applications may be authenticated or plugged in to the microservices manager, for example, with user-supplied application credentials to the manager, without requiring reauthentication each time the managed application is used alone or in combination with other applications.

Microservices may be connected via a GUI. For example, microservices may be displayed as logical blocks within a window, frame, or other element of a GUI. A user may drag and drop microservices into an area of the GUI used to build an application. The user may connect the output of one microservice into the input of another microservice using directed arrows or any other GUI element. The application builder may run verification tests to confirm that the output and inputs are compatible (e.g., by checking the datatypes, size restrictions, etc.) cl 6.1. Triggers

The techniques described above may be encapsulated into a microservice, according to one or more embodiments. In other words, a microservice may trigger a notification (into the microservices manager for optional use by other plugged-in applications, herein referred to as the “target” microservice) based on the above techniques and/or may be represented as a GUI block and connected to one or more other microservices. The trigger condition may include absolute or relative thresholds for values, and/or absolute or relative thresholds for the amount or duration of data to analyze, such that the trigger to the microservices manager occurs whenever a plugged-in microservice application detects that a threshold is crossed. For example, a user may request a trigger into the microservices manager when the microservice application detects that a value has crossed a triggering threshold.

A trigger, when satisfied, may output data for consumption by the target microservice. Alternatively or additionally, when satisfied, a trigger may output a binary value indicating that the trigger has been satisfied, and/or may output the name of the field or other context information for which the trigger condition was satisfied. Additionally or alternatively, the target microservice may be connected to one or more other microservices such that an alert is input to the other microservices. Other microservices may perform responsive actions based on the above techniques, including, but not limited to, deploying additional resources, adjusting system configurations, and/or generating GUIs.

### 6.2. Actions

A plugged-in microservice application may expose actions to the microservices manager. The exposed actions may receive, as input, data or an identification of a data object or location of data that causes data to be moved into a data cloud.

The exposed actions may receive, as input, a request to increase or decrease existing alert thresholds. The input may identify existing in-application alert thresholds and whether to increase, decrease, or delete the threshold. The input may request the microservice application to create new in-application alert thresholds. The in-application alerts may trigger alerts to the user while logged into the application or may trigger alerts to the user, using default or user-selected alert mechanisms available within the microservice application itself, rather than through other applications plugged into the microservices manager.

The microservice application may generate and provide an output based on input that identifies, locates, or provides historical data, and defines the extent or scope of the requested output. The action, when triggered, causes the microservice application to provide, store, or display the output, for example, as a data model or as aggregate data that describes a data model.

### 7. HARDWARE OVERVIEW

In one or more embodiments, techniques described herein are implemented by one or more special-purpose computing devices. The special-purpose computing device(s) may be hard-wired to perform the techniques, and/or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination thereof. Such special-purpose computing devices may also combine custom hard-wired logic, ASICs, FPGAs, or NPUs with custom programming to accomplish the techniques. A special-purpose computing device may be desktop computer systems, portable computer systems, handheld devices, networking devices, or any other device that incorporates hard-wired and/or program logic to implement the techniques.

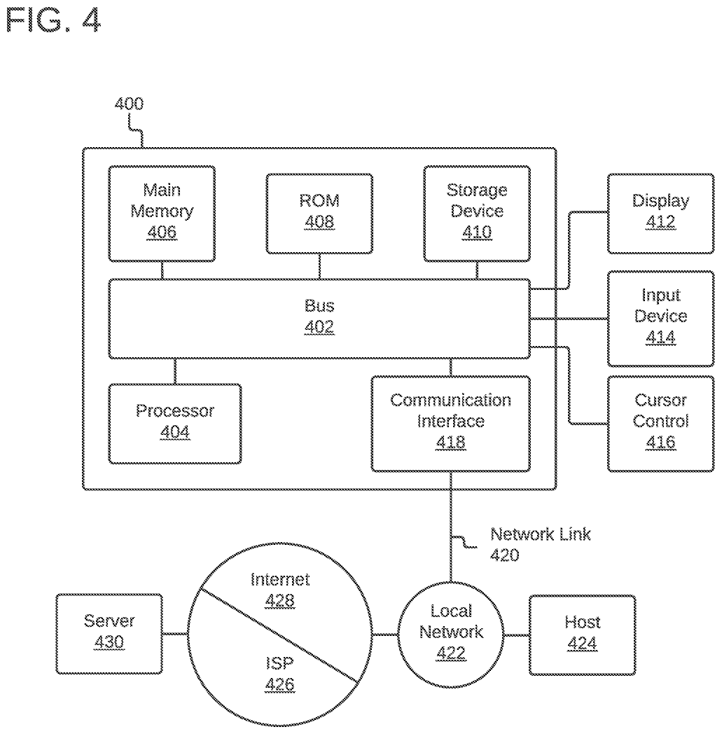

For example, FIG. 4 is a block diagram that illustrates a computer system 400 upon which one or more embodiments of the invention may be implemented. The computer system 400 includes a bus 402 or other communication mechanism for communicating information, and a hardware processor 404 coupled with bus 402 for processing information. The hardware processor 404 may be, for example, a general-purpose microprocessor.

The computer system 400 also includes a main memory 406, such as a random access memory (RAM) or other dynamic storage device, coupled to bus 402 for storing information and instructions to be executed by processor 404. The main memory 406 also may be used for storing temporary variables or other intermediate information during execution of instructions to be executed by processor 404. Such instructions, when stored in non-transitory storage media accessible to the processor 404, render the computer system 400 into a special-purpose machine that is customized to perform the operations specified in the instructions.

The computer system 400 further includes a read only memory (ROM) 408 or other static storage device coupled to the bus 402 for storing static information and instructions for the processor 404. A storage device 410, such as a magnetic disk or optical disk, is provided and coupled to the bus 402 for storing information and instructions.

The computer system 400 may be coupled via the bus 402 to a display 412, such as a cathode ray tube (CRT), for displaying information to a computer user. An input device 414, including alphanumeric and other keys, is coupled to the bus 402 for communicating information and command selections to the processor 404. Another type of user input device is cursor control 416, such as a mouse, a trackball, or cursor direction keys for communicating direction information and command selections to the processor 404 and for controlling cursor movement on the display 412. This input device typically has two degrees of freedom in two axes, a first axis (e.g., x) and a second axis (e.g., y), that allows the device to specify positions in a plane.

The computer system 400 may implement techniques described herein using customized hard-wired logic, one or more ASICs or FPGAs, firmware, and/or program logic which in combination with the computer system 400 causes or programs the computer system 400 to be a special-purpose machine. In one or more embodiments, the techniques herein are performed by the computer system 400 in response to the processor 404 executing one or more sequences of one or more instructions contained in the main memory 406. Such instructions may be read into the main memory 406 from another storage medium, such as the storage device 410. Execution of the sequences of instructions contained in the main memory 406 causes the processor 404 to perform the process steps described herein. Alternatively, hard-wired circuitry may be used in place of or in combination with software instructions.

The term “storage media” as used herein refers to any non-transitory media that store data and/or instructions that cause a machine to operate in a specific fashion. Such storage media may include non-volatile media and/or volatile media. Non-volatile media includes, for example, optical or magnetic disks, such as storage device 410. Volatile media includes dynamic memory, such as the main memory 406. Common forms of storage media include, for example, a floppy disk, a flexible disk, hard disk, solid state drive, magnetic tape, or any other magnetic data storage medium, a read-only compact disc (CD-ROM), any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires of the bus 402. Transmission media can also take the form of acoustic or light waves, such as those generated during radio frequency (RF) and infrared data communications.

Various forms of media may be involved in carrying one or more sequences of one or more instructions to the processor 404 for execution. For example, the instructions may initially be carried on a magnetic disk or solid-state drive of a remote computer. The remote computer can load the instructions into its dynamic memory and send the instructions over a telephone line or other communications medium, using a modem. A modem local to the computer system 400 can receive the data on the telephone line or other communications medium and use an infrared transmitter to convert the data to an infrared signal. An infrared detector can receive the data carried in the infrared signal and appropriate circuitry can place the data on the bus 402. The bus 402 carries the data to the main memory 406, from which the processor 404 retrieves and executes the instructions. The instructions received by the main memory 406 may optionally be stored on the storage device 410, either before or after execution by processor 404.

The computer system 400 also includes a communication interface 418 coupled to the bus 402. The communication interface 418 provides a two-way data communication coupling to a network link 420 that is connected to a local network 422. For example, the communication interface 418 may be an integrated services digital network (ISDN) card, cable modem, satellite modem, or a modem to provide a data communication connection to a corresponding type of telephone line. As another example, the communication interface 418 may be a local area network (LAN) card configured to provide a data communication connection to a compatible LAN. Wireless links may also be implemented. In any such implementation, the communication interface 418 sends and receives electrical, electromagnetic, or optical signals that carry digital data streams representing various types of information.

The network link 420 typically provides data communication through one or more networks to other data devices. For example, the network link 420 may provide a connection through a local network 422 to a host computer 424 or to data equipment operated by an Internet Service Provider (ISP) 426. The ISP 426 in turn provides data communication services through the world wide packet data communication network now commonly referred to as the “Internet” 428. The local network 422 and Internet 428 both use electrical, electromagnetic, or optical signals that carry digital data streams. The signals through the various networks and the signals on the network link 420 and through the communication interface 418, which carry the digital data to and from the computer system 400, are example forms of transmission media.

The computer system 400 can send messages and receive data, including program code, through the network(s), network link 420, and communication interface 418. In the Internet example, a server 430 might transmit a requested code for an application program through the Internet 428, ISP 426, local network 422, and communication interface 418.

The received code may be executed by processor 404 as it is received, and/or may be stored in the storage device 410 or other non-volatile storage for later execution.

### 8. MISCELLANEOUS; EXTENSIONS

Embodiments are directed to a system with one or more devices that include a hardware processor and that are configured to perform any of the operations described herein and/or recited in any of the claims below.

In one or more embodiments, a non-transitory computer-readable storage medium stores instructions which, when executed by one or more hardware processors, cause performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. One or more non-transitory machine-readable media storing instructions that, when executed by one or more processors, cause performance of operations comprising:
obtaining baseline data associated with one or more digital marketing campaigns;
configuring an anomaly detection model to detect anomalies in digital marketing data, based at least on the baseline data;
receiving a live stream of a set of digital marketing data associated with a particular digital marketing campaign that is currently being executed;
while the particular digital marketing campaign is being executed: applying the anomaly detection model to the set of digital marketing data, to determine if the set of digital marketing data comprises an anomaly relative to the baseline data;
prior to completion of the particular digital marketing campaign and responsive to determining that the set of digital marketing data comprises the anomaly relative to the baseline data, executing an action to address the anomaly.

2. The one or more non-transitory machine-readable media of claim 1, wherein:
obtaining the baseline data comprises obtaining prior digital marketing data associated with the particular digital marketing campaign; and
wherein obtaining the baseline data comprises:
training a machine learning model to determine one or more baseline performance metrics for digital marketing campaigns;
applying the machine learning model to the prior digital marketing data associated with the particular digital marketing campaign, to obtain the one or more baseline performance metrics for the particular digital marketing campaign.

3. The one or more non-transitory machine-readable media of claim 1, wherein executing the action to address the anomaly comprises one or more of modifying or terminating the particular digital marketing campaign.

4. The one or more non-transitory machine-readable media of claim 1, wherein the live stream of the set of digital marketing data comprises data indicating one or more performance metrics associated with the particular digital marketing campaign.

5. The one or more non-transitory machine-readable media of claim 1, wherein obtaining the baseline data comprises receiving a plurality of sets of digital marketing data associated, respectively, with a plurality of digital marketing campaigns, wherein at least two digital marketing campaigns in the plurality of digital marketing campaigns are associated with different tenants of a multi-tenant digital marketing platform.

6. The one or more non-transitory machine-readable media of claim 5, wherein obtaining the baseline data further comprises determining one or more baseline campaign performance metrics, based at least on the digital marketing data associated with the plurality of digital marketing campaigns.

7. The one or more non-transitory machine-readable media of claim 5, the operations further comprising:
selecting the plurality of digital marketing campaigns from a plurality of available digital marketing campaigns, based at least on one or more campaign selection criteria.

8. The one or more non-transitory machine-readable media of claim 7, wherein selecting the plurality of digital marketing campaigns from the plurality of available digital marketing campaigns comprises:
training a machine learning model to identify similarities between digital marketing campaigns;
applying the machine learning model to the available digital marketing campaigns, to select the plurality of digital marketing campaigns.

9. The one or more non-transitory machine-readable media of claim 1, wherein obtaining the baseline data comprises obtaining a baseline data schema for digital marketing data associated with the particular digital marketing campaign.

10. The one or more non-transitory machine-readable media of claim 1, wherein obtaining the baseline data comprises obtaining one or more user-defined baseline campaign performance metrics.

11. The one or more non-transitory machine-readable media of claim 1, wherein:
configuring the anomaly detection model comprises training a machine learning model to detect anomalies in digital marketing data, using the baseline data as training data;
applying the anomaly detection model to the set of digital marketing data comprises applying the machine learning model to the set of digital marketing data.

12. The one or more non-transitory machine-readable media of claim 11, the operations further comprising:
updating the machine learning model based at least on the anomaly.

13. The one or more non-transitory machine-readable media of claim 1, wherein configuring the anomaly detection model comprises configuring a set of one or more anomaly detection rules, based at least on the baseline data.

14. The one or more non-transitory machine-readable media of claim 1, the operations further comprising:
generating an anomaly score associated with the anomaly;
performing a comparison of the anomaly score with at least one predetermined threshold value;
determining, based at least on the comparison of the anomaly score with the at least one predetermined threshold value, a severity of the anomaly.

15. The one or more non-transitory machine-readable media of claim 14, wherein the severity of the anomaly indicates that the anomaly is a good anomaly.

16. The one or more non-transitory machine-readable media of claim 14, the operations further comprising:
based at least on the anomaly score, determining successfulness of the digital marketing campaign.

17. The one or more non-transitory machine-readable media of claim 1, the operations further comprising:
presenting, in a graphical user interface, information that describes the action to address the anomaly;
receiving, via the graphical user interface, a user instruction to execute the action;
wherein executing the action to address the anomaly is performed responsive to receiving the user instruction.

18. The one or more non-transitory machine-readable media of claim 1, the operations further comprising:
based at least on the anomaly, determining a micro-segmentation of a prospective customer base such that members of the prospective customer base who belong to the micro-segmentation tend to be more strongly associated with the anomaly than members of the prospective customer base who do not belong to the micro-segmentation.

19. A system comprising:
at least one device comprising one or more hardware processors,
the system being configured to perform operations comprising:
obtaining baseline data associated with one or more digital marketing campaigns;
configuring an anomaly detection model to detect anomalies in digital marketing data, based at least on the baseline data;
receiving a live stream of a set of digital marketing data associated with a particular digital marketing campaign that is currently being executed;
while the particular digital marketing campaign is being executed: applying the anomaly detection model to the set of digital marketing data, to determine if the set of digital marketing data comprises an anomaly relative to the baseline data;
prior to completion of the particular digital marketing campaign and responsive to determining that the set of digital marketing data comprises the anomaly relative to the baseline data, executing an action to address the anomaly.

20. A method comprising:
obtaining baseline data associated with one or more digital marketing campaigns;
configuring an anomaly detection model to detect anomalies in digital marketing data, based at least on the baseline data;
receiving a live stream of a set of digital marketing data associated with a particular digital marketing campaign that is currently being executed;
while the particular digital marketing campaign is being executed: applying the anomaly detection model to the set of digital marketing data, to determine if the set of digital marketing data comprises an anomaly relative to the baseline data;
prior to completion of the particular digital marketing campaign and responsive to determining that the set of digital marketing data comprises the anomaly relative to the baseline data, executing an action to address the anomaly,
wherein the method is performed by at least device comprising one or more hardware processors.
